(19) United States
(12) Patent Application Publication
(10) Pub. No.: US 2002/0078282 A1
(43) Pub. Date: Jun. 20, 2002

(54) Target directed completion for bus transactions

(75) Inventors: Bernard Charles Drerup, Austin, TX (US); Richard Nicholas Iachetta Jr., Pfluqerville, TX (US)

Correspondence Address: Andrew J. Dillon, FELSMAN, BRADLEY, VADEN, GUNTER & DILLON, LLP, Lakewood on the Park, Suite 350, 7600B North Capital of Texas Highway, Austin, TX, 78731, US

(73) Assignee: International Business Machines Corporation

(21) Appl. No.: 09/740,178

(22) Filed: Dec. 18, 2000

(51) Int. Cl. G06F 13/00

(52) U.S. Cl. 710/107

(57) ABSTRACT

A method and apparatus for reducing latency and overhead bandwidth consumption in computer bus transactions. In accordance with the method of the present invention, a transaction request that is delivered over a shared bus from an initiator device is claimed by a target device. If the target device is not currently ready to process the transaction request, the target deasserts a dedicated ready signal device and delivers a retry message to the initiator. The retry message terminates the transaction request on the shared bus and instructs the initiator to re-deliver the request upon assertion of the dedicated target ready signal.

### BACKGROUND OF THE INVENTION

1. Technical Field

The present invention relates in general to bus transactions and in particular to reducing the latency and bandwidth overhead associated with bus transactions.

2. Description of the Related Art

Computer systems and other digital electronic systems are made up of individual devices that must communicate with each other. These devices are interconnected via busses which serve as the inter-device communication medium. A variety of data transfer protocols are available for different bus types.

Devices that communicate via bus transactions fall into one of two categories—initiators or targets—at any given time. Sometimes a device is both an initiator and a target. An initiator (sometimes called a “busmaster”) is the device that initiates a transaction, such as a read or write, onto the bus. The initiator typically provides a target address and other control information relating to the transaction in conformity with the bus protocol.

The target is the device that the initiator communicates with. There are typically several targets listening to each transaction mastered by the various initiators. Each target utilizes the address and other supplemental control information to determine whether or not the transaction is directed to it. If a target determines that the transaction is meant for it, the target “claims” the transaction according to the bus protocol. If the transaction is a write, the initiator delivers the write data on the bus where it is accepted by the target. For a read transaction, the target delivers the requested data on the bus where it is accepted by the initiator.

The performance of such bus transactions is affected by three main factors. Two of these factors are the bus protocol overhead and the speed with which the initiator can accept or provide the transacted data. The overhead associated with the bus protocol is generally fixed and is not addressed by the invention disclosed herein. The speed of the initiator is usually easy to improve with buffering. For example, if the initiator never writes more than it has buffered, or asks for more read data than is has buffer space for, then the initiator will always operate at zero wait states.

The third performance factor, to which the present invention is directed, is the speed with which the target can provide or accept the transacted data to or from the initiator in response to a requested transaction. The speed of the target response is not as easily optimized as the speed of the initiator because there will almost always be cases in which the target cannot respond in zero wait states. Since the target is not the initiator of the transaction, it cannot know in advance which target address the initiator will select, nor can it anticipate the amount of read or write data the initiator will request. Unless the target has coincidentally buffered the particular block of data requested in a read transaction, some time is required for the target to fetch the data before returning it to the initiator. For write operations, the target can post certain writes thus enabling the target to respond in zero waits states for data blocks not exceeding the size of its write buffers. For non-postable writes, however, the initiator must wait while the target completes the write.

Several methods have been devised to address the target delay problem. The first and simplest method is a technique that utilizes “wait states.” With this method, the bus protocol enables the target to instruct the initiator to wait until the read data is ready or the write is complete. A wait state transaction begins with the initiator providing a target address and other transaction control information. The target responds by claiming the transaction and signaling wait on the bus. The target continues to signal wait until it can provide the read data or has accepted the write data. If the transaction was for a block of data rather than just one piece, the target may signal wait in between transference of each piece of data. The major disadvantage of this approach is that the wait instruction blocks all other bus traffic such that the bus is tied up and unusable the entire time that the target is signaling wait. During wait states, initiators cannot communicate with other devices, resulting in wasted bus bandwidth that could otherwise support parallel fetches or data transfer in parallel with fetches.

The second method for addressing target delay is known as “delayed transactions.” Delayed transactions are implemented in the 2.1 Revision of the Peripheral Component Interconnect (PCI) standard. The basic principle behind delayed transactions is to allow a target device to acknowledge receipt of an initiator request and then release the bus to permit other bus transactions to commence while the requested transaction is pending.

Upon receiving a transaction request, the target signals retry back to the initiator. In accordance with the delayed transaction protocol, retry instructs the initiator to try this same transaction again at a later time. In the case of a read, the target begins to fetch the requested data into its buffer after signaling retry. In the case of a write, the target actually starts to perform the write with the data it captured from the first retried transaction. It should be noted that delayed writes are only useful for single data phase writes (not block writes). If the initiator retries the transaction before the target has retrieved all of the requested read data, or before completion of a requested write, the target will again signal retry. When the target is ready to deliver the requested read data or has completed the requested write, the target will stop signaling retry and will terminate the transaction by transferring the data according to the bus protocol.

Compared with wait states, delayed transactions have the advantage that other initiators (or the same one) can send transactions to other targets while the first target is busy processing its transaction. Multiple devices can be fetching read data or working on writes simultaneously, each completing when ready. The disadvantage of delayed transactions is the considerable amount of overhead bandwidth required for initiators to repeatedly request a pending transaction. Since an initiator does not know how long a target will take to perform its transaction, the initiator typically repeats the transaction request immediately (as soon as it is granted bus access by the bus arbiter) resulting in a significant amount of bus bandwidth being consumed by such retries. This becomes a problem when multiple initiators have outstanding delayed reads and one of the targets is ready to complete. Due to the pre-determined arbitration order, several initiators might deliver retried transactions to targets that are not ready, while an initiator having a ready target must wait.

The third method for addressing target delay is known as “rerun transactions.” In response to receipt of a transaction request, the target responds with a rerun response. According to the rerun transaction protocol (as utilized in the PowerPC 6XX bus, for example), the rerun response indicates to the initiator that the target is processing the request and will inform the initiator when the target is finished. When the target has buffered the read data or is ready to accept the write data, it becomes a pseudo-initiator and runs a rerun transaction back to the original initiator. Upon receiving the rerun transaction, the initiator repeats the original transaction a second time whereupon the transaction is completed.

The rerun transaction method eliminates the wasted bandwidth of repeated retries used in the delayed transactions method. However, the rerun transaction itself imparts additional latency to the transaction. In addition the rerun transaction method requires additional device complexity of the target since the target must serve as a pseudo-initiator (including requesting the bus, etc.) to initiate the rerun transaction. The complexity of the initiator is also increased because it now must serve as a pseudo-target for receiving the rerun transaction.

The fourth and highest performing conventional method for addressing target delay is known as “split transactions,” which are utilized on the PCI-X bus version 1.0. Split transactions are similar to rerun transactions except that instead of asserting retry or rerun, the target signals split_response. In accordance with the split transaction protocol, the split_response informs the initiator that the target is processing the request and that upon completion, the target will itself become an initiator and will complete the transaction. When the target has buffered the read data, or is ready to accept the write data, it becomes an initiator and signals split_completion back to the original initiator. In the language of PCI-X, the target becomes a “completer” on the bus and the original initiator of the transaction (the requester) becomes the target of the split completion.

The split transaction method eliminates the additional latency and bandwidth imparted by the rerun transaction at the cost of requiring greater device complexity for both the initiator and the target. Since the rerun transaction is an address-only transaction having no data phases or waits states, full dual functionality is not required for the initiator or the target. For the split transaction method, however, initiators must alternately serve as fully functional targets, and targets must alternately serve as fully functional initiators, each capable of running most of the bus protocol including burst transactions.

In light of the aforementioned transaction processing methods that either increase overhead bandwidth consumption and/or increase the device complexity, it would be useful to provide an apparatus and method for addressing the problem of target delay uncertainty without such disadvantages.

### SUMMARY OF THE INVENTION

A method and apparatus for reducing latency and overhead bandwidth consumption in computer bus transactions are disclosed herein. In accordance with the method of the present invention, a transaction request that is delivered over a shared bus from an initiator device is claimed by a target device. If the target device is not currently ready to process the transaction request, the target deasserts a dedicated ready signal device and delivers a retry message to the initiator. The retry message terminates the transaction request on the shared bus and instructs the initiator to re-deliver the request upon assertion of the dedicated target ready signal.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 illustrates a system-on-chip in which the target directed completion of the present invention may be advantageously utilized;

FIG. 2 depicts a target directed completion circuit in accordance with one embodiment of the present invention;

FIG. 3 illustrates a target directed completion circuit in accordance with an alternate embodiment of the present invention; and

FIG. 4 is a flow diagram depicting steps performed during a target directed completion bus transaction in accordance with a preferred embodiment of the present invention.

### DETAILED DESCRIPTION OF THE PREFERRED EMBODIMENT

This invention is described in a preferred embodiment in the following description with reference to the figures. While this invention is described in terms of the best mode for achieving this invention's objectives, it will be appreciated by those skilled in the art that variations may be accomplished in view of these teachings without deviating from the spirit or scope of the present invention.

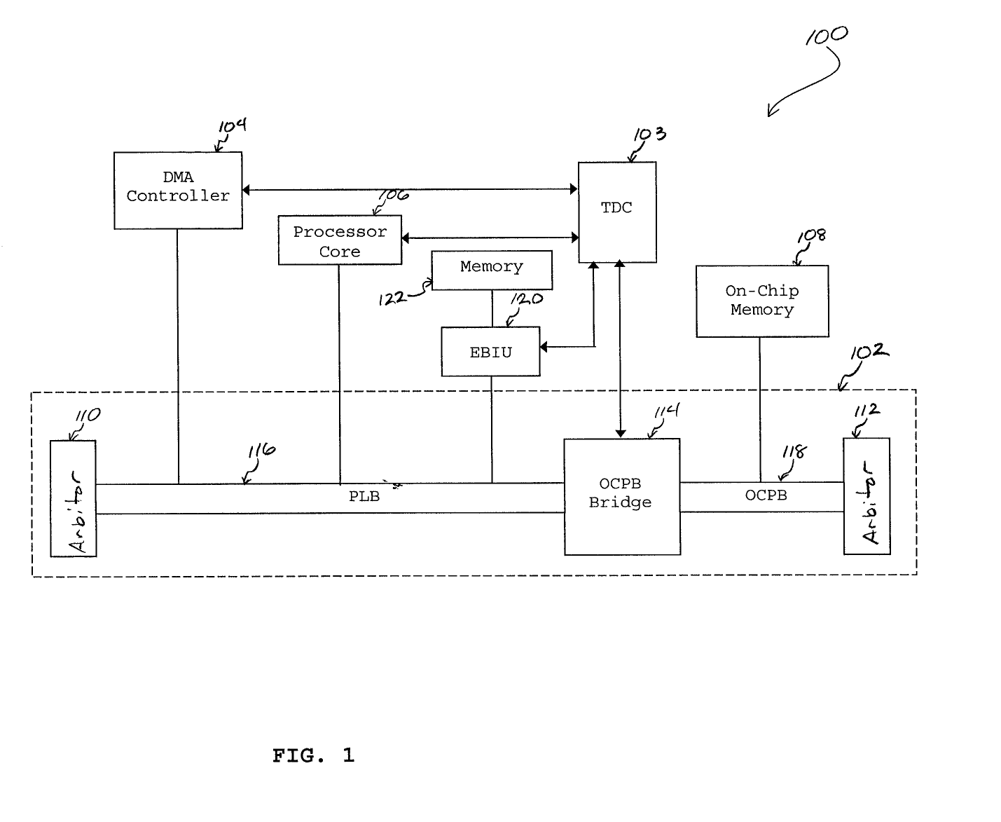

With reference now to the figures wherein like reference numerals refer to like and corresponding parts throughout, and in particular with reference to FIG. 1, there is illustrated a System-On-Chip (SOC) 100 in which target directed completion in accordance with the teachings of the present invention may be advantageously utilized. An SOC typically comprises several complex circuit blocks, or modules, within the bounds of a single chip. The basic concept behind SOC design involves placing logic cores or memory macros in a chip much the same way shelf components are placed on printed circuit boards, and then adding memory, logic, and data path connections in order to implement system level integration. SOC's address the need for higher chip densities wherein more of the computer system functionality such as audio, video, and graphics, that have heretofore been coupled to a processor at the card level, are integrated onto the same IC as the system processor. As depicted in FIG. 1, SOC 100 includes a Direct Memory Access (DMA) controller 104, a processor core 106, an on-chip memory device 108, an External Bus Interface Unit (EBIU) device 120.

Having several high-level functions combined on a single chip, the bandwidth requirements of the on-chip busses within SOC 100 are considerable. A processor local bus (PLB) 116 and an on-chip peripheral bus (OCPB) 118 are included within a core connect system 102 that is designed to provide on-chip communication among the various cores and peripheral devices within SOC 100. In a preferred embodiment of the present invention, core connect system 102 is designed in accordance with IBM's CoreConnect™ bus architecture that serves as the foundation of IBM Blue Logic™ for SOC implementations.

In accordance with PLB standards, PLB 116 is a synchronous bus supporting several initiator devices. PLB 116 is designed for high bandwidth applications and thus includes protocol features such as burst transfers and pipelining. OCPB 118 is also synchronous supporting single-cycle data transfers between initiators and targets.

On-chip busses such as PLB 116 and OCPB 118 are far less limited by the number of input/output (I/O) points within an interface. Many off-chip architectures have a reduced number of I/O pins due to packaging constraints thus degrading bus utility. On-chip busses may have many more interface signals without the associated cost in terms of high pin count packages. Separate control and data busses are feasible since the penalty of additional I/O is reduced.

DMA controller 104 and processor core 106 communicate with other devices sharing PLB 116 in accordance with instructions from an arbiter device 110. EBIU device 120 provides access to an external memory device 122 by an off-chip bus. An OCPB bridge 114 provides access to and from devices sharing OCPB 118 such as an on-chip memory device 108 in accordance with instructions from an arbiter 112. Arbiters 110 and 112 coordinate data transfer requests from DMA controller 104 and processor core 106 to EBIU device 120 and OCPB bridge 114. Such data transfer requests include read and write requests in which DMA controller 104 and processor core 106 act as bus initiators (sometimes called bus masters) in delivering such requests, and EBIU device 120 and OCPB bridge 114 serve as the targets that receive the transaction requests.

A series of signal lines within PLB 116 and OCPB 118 couple target bus controller devices 120 and 114 with arbiters 110 and 112 respectively. Various control signals are delivered across such signal lines including address valid, address acknowledge, write data acknowledge, write complete, read data acknowledge, read complete, read word address, and read data transfer.

Processor core 106 and DMA controller 104 are connected to arbiter 110 by a series of signal lines for communicating various control signals including request, address, address acknowledge, transfer qualifiers, write data bus, write data acknowledge, read data bus, and read data acknowledge.

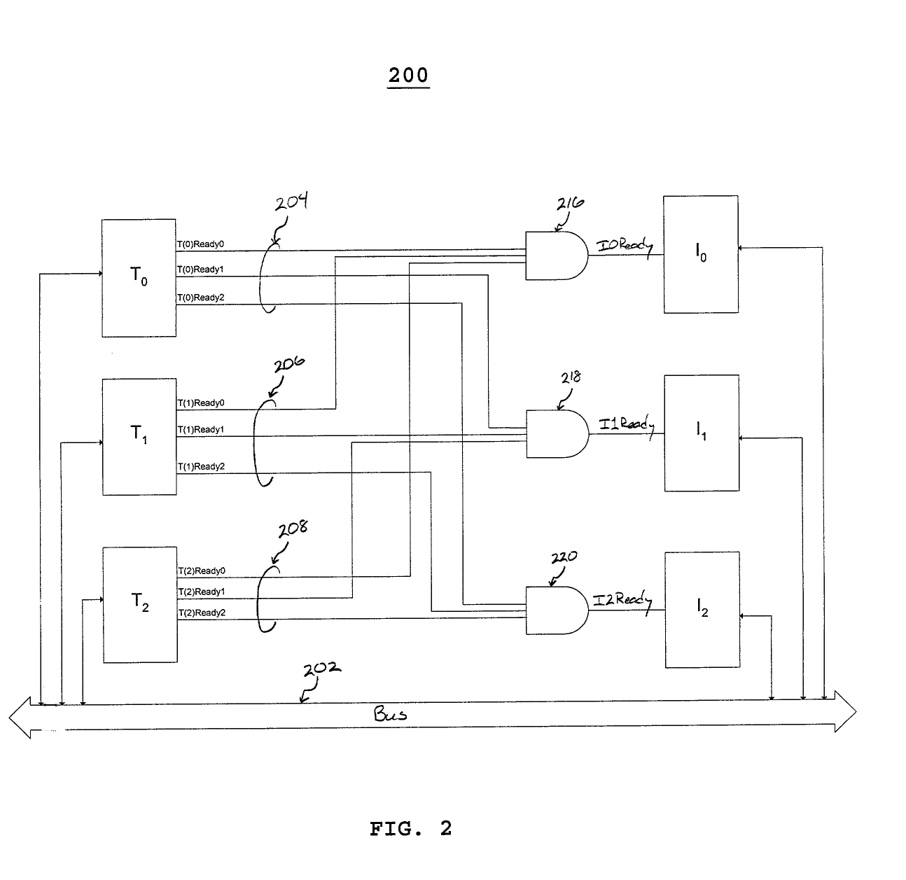

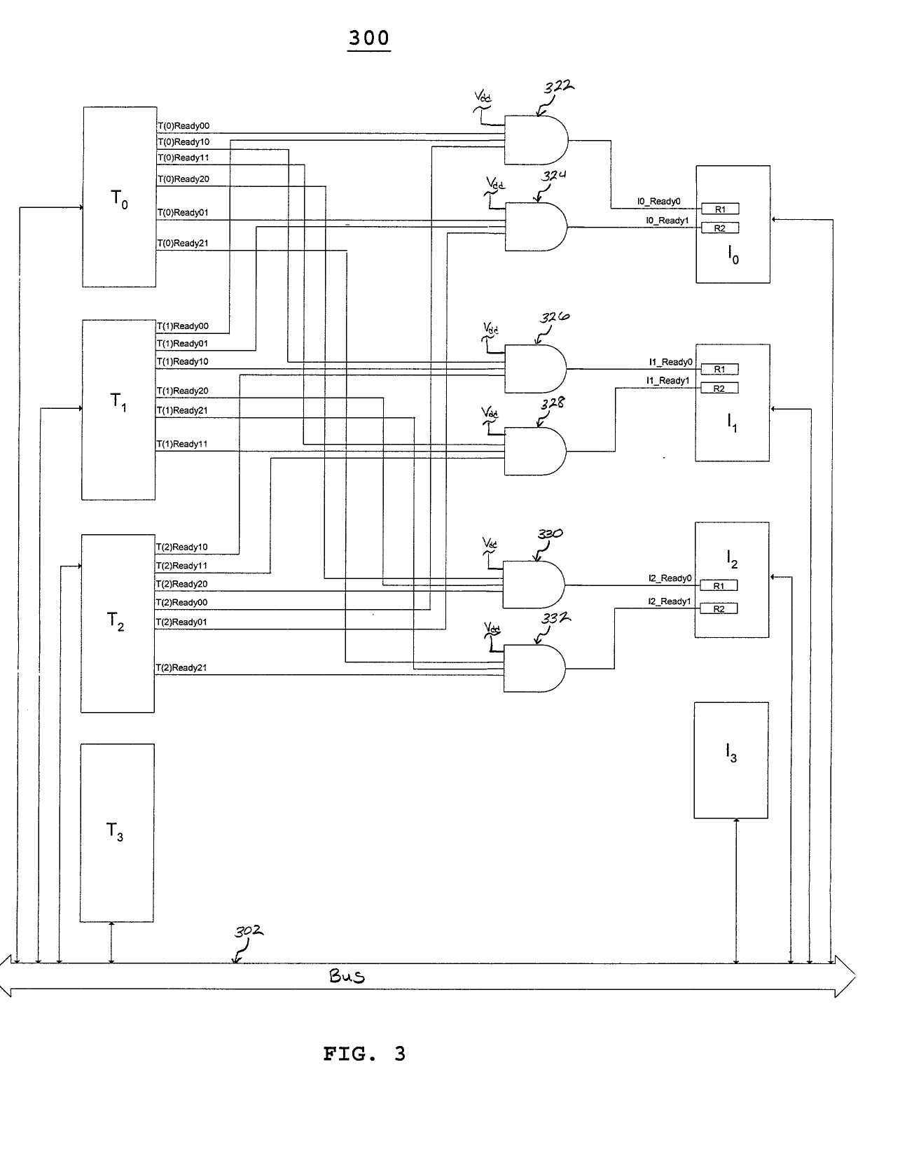

As depicted in FIG. 1, SOC 100 further comprises a target directed completion device 103 for providing an enhanced bus transaction interface between EBIU device 120, processor core 106, OCPB bridge 114, and DMA controller 104. In accordance with a preferred embodiment of the present invention, and as explained in further detail with reference to FIGS. 2 and 3, target directed completion device 103 include circuit means for delivering dedicated ready signals from target EBPU device 120 or OCBP bridge 114, for bus transactions initiated by processor core 106 and DMA controller 104 that serve as initiators. Such ready signals are generated by a target devices when it is ready to complete a transaction request from one of the initiator devices. To avoid interrupting traffic on PLB 116 and OCPB 118, target directed completion device 103 delivers the ready signals over dedicated lines external to PLB 116 or OCPB 118.

The method and system of the present invention, as embodied in the figures provided herein, is particularly well-suited for implementation within a bus system that utilizes “delayed transaction” to address target-induced transaction delay. The basic principle behind delayed transactions is to allow a target device to acknowledge receipt of an initiator request and then release the bus to permit other bus transactions to commence while the requested transaction is pending.

Upon receiving a transaction request, a target device signals retry back to the initiator. In accordance with the delayed transaction protocol, retry instructs the initiator to try this same transaction again at a later time. In the case of a read, the target begins to fetch the requested data into its buffer after signaling retry. In the case of a write, the target begins the write with the data it captured from the first retried transaction. If the initiator retries the transaction before the target has retrieved all of the requested read data, or before completion of a requested write, the target will again signal retry. When the target is ready to deliver the requested read data or has completed the requested write, the target will stop signaling retry and the transaction will terminate.

The disadvantage of conventional delayed transactions is the considerable amount of overhead bandwidth required for initiators to repeatedly request a pending transaction. Since an initiator does not know how long a target will take to perform its transaction, the initiator typically repeats the transaction request immediately (as soon as it is granted bus access by the bus arbiter) resulting in a significant amount of bus bandwidth being consumed by such retries. This becomes a problem when multiple initiators have outstanding delayed reads and one of the targets is ready to complete. Due to the pre-determined arbitration order, several initiators might deliver retried transactions to targets that are not ready, while an initiator having a ready target must wait.

Central to each of the following target directed completion (TDC) embodiments, as described with reference to FIGS. 2, 3, and 4, is a target directed completion signaling system that is combined with the conventional retry methodology of delayed transactions that enables a target device to guide the initiator device in determining when to retry a previously delayed transaction request. Specifically, a dedicated target ready signal is utilized in addition to a conventional retry message to accurately inform an initiator device whether or not a target is ready to process a previously delivered transaction request. The target ready signaling convention adopted in the following embodiments employs an asserted ready signal to instruct an initiator device to act upon a retry message, while a deasserted target ready signal instructs the initiator device that the target device is not currently ready and thus to defer redelivery of the original transaction request.

With reference to FIG. 2, there is depicted a TDC circuit 200 in accordance with one embodiment of the present invention. TDC circuit 200 may be implemented within a shared on-chip bus to minimize the latency and overhead bandwidth consumption in computer bus transactions. As illustrated in FIG. 2, TDC circuit 200 includes three target devices, T₀, T₁, and T₂. These target devices are analogous to OCPB bridge 114 and EBIU device 120 in that they are included within the category of devices that receive transaction requests from initiator devices over a shared bus. Three initiator devices, I₀, I₁, and I₂. share a bus 202 with T₀, T₁, and T₂. Initiator devices I₀, I₁, and I₂ include functionality for delivering bus transaction requests, such as memory read and write requests, to the target devices over shared bus 202.

TDC circuit 200 incorporates circuitry for implementing the functionality of TDC device 103 in FIG. 1. In the embodiment depicted in FIG. 2, TDC circuit 200 includes dedicated lines 204, 206, and 208 and three three-input logic AND gates 216, 218, and 220 for delivering asserted or deasserted ready signals from any of targets T₀, T₁, and T₂ to any of initiators I₀, I₁, and I₂ as singular initiator inputs I0Ready, I1Ready, and I2Ready. For backward compatibility with conventional delayed transaction devices, each of the target ready output lines are asserted high as the non-transactional default. Although lines 204, 206, and 208 and AND gates 216, 218, and 220 are depicted as external to shared bus 202, it should be noted that such functionality can be incorporated within the bus without departing from the spirit or scope of the present invention.

As depicted in FIG. 2, each target device includes three target ready outputs, wherein each individual target ready output is associated with a different initiator device. Target device T₀, for example, has T(0)Ready0, T(0)Ready1, and T(0)Ready2 output lines connected to initiator devices I₀, I₁, and I₂, respectively, via AND gates 216, 218, and 220. When all target ready inputs into a particular AND gate are asserted high, the AND gate delivers an asserted ready signal to the appropriate initiator device.

A deasserted ready signal carried over initiator inputs I0Ready, I1Ready, or I2Ready instructs the corresponding initiator devices to refrain from resending a previously delivered transaction request. Conversely, an asserted ready signal delivered from a target device that is currently prepared to process a previously delivered transaction request instructs the initiator device to now act upon the retry message, i.e., redeliver the original transaction request or send a new transaction. When one of target devices T₀, T₁, or T₂, receives a transaction request that it is currently unprepared to process, the target sends a retry message to the initiator over shared bus 202 and deasserts the appropriate target ready signal. The initiator does not respond to the retry message until the target device asserts the target ready signal.

For a read request delivered from initiator device I₁ to target device T₀ over shared bus 202, a read data request is transmitted from initiator device I₁ to shared bus 202. The read request includes control information such as the Master ID (MID) address of the initiator that target device T₀ device utilizes to claim the transaction and identify the sending initiator. After claiming the read request from shared bus 202, target device T₀ sends a retry message to initiator device I₁ and deasserts T(0)Ready1. In accordance with the teachings of the present invention, the retry message performs two main functions. First, it notifies the current bus master, I₁, that the read request transaction on shared bus 202 is terminated, thus freeing bus 202 for other traffic. Second, the retry message instructs initiator device I₁ to monitor its ready input, I1Ready, to detect an asserted ready signal indicating that target device T₀ is ready to perform the steps necessary to complete the requested read.

Target device T₀ includes logic for asserting T(0)Ready1 when T₀ is ready to process the read request. When T(0)Ready1 is asserted, the output of AND gate 218 asserts I1Ready. Upon detecting an asserted I1Ready signal, initiator device I₁ resends the read request to target device T₀ which is now ready to process the request and the transaction is completed. The processing of a write request within TDC circuit 200 follows the same protocol as for a read request.

The embodiment illustrated in FIG. 2 may be implemented for a system in which each of initiator devices I₀, I₁, and I₂ support only one outstanding bus transaction. It should be noted that target devices T₀, T₁, and T₂ may support more than one and up to three outstanding bus transactions. If a target device receives a transaction request while it is processing the maximum number of transactions that it can support, the target responds with a retry message with the ready signal for the initiator deasserted so that the initiator will not resend the request while the target is busy with the pending transactions. When the target buffers are freed, the target then asserts the target ready signal corresponding to the requesting initiator so that the transaction request will be re-delivered. The target will not be ready to complete the transaction, but will be prepared to queue the request within its buffers. Thus, in response to receiving the resent transaction, the target responds with another retry message and a deasserted ready signal.

Referring to FIG. 3, there is illustrated a TDC circuit 300 that permits initiator devices to support more than one outstanding shared bus transaction in accordance with an alternate embodiment of the present invention. TDC circuit 300 includes three target devices T₀, T₁, and T₂ and three initiator devices I₀, I₁, and I₂ that are designed to implement target directed completion of bus transactions as disclosed herein. A legacy target device T₃ and a legacy initiator device I₃, both of which support conventional delayed bus transaction without TDC functionality are also connected to shared bus 302.

In the depicted embodiment, each of initiator devices I₀, I₁, and I₂ receives two target ready inputs, thus enabling each initiator to handle up to two outstanding transactions. As further depicted in FIG. 3, initiator devices I₀, I₁, and I₂ include a pair of dedicated buffer outputs R1 and R2 that receive target ready signal from any of the target devices via AND gates 322, 324, 326, 328, 330, and 332.

The protocol employed by TDC circuit 300 for read and write operations is similar to that described with reference to TDC circuit 200 except that when delivering a transaction request on shared bus 302, an initiator device includes a TDC buffer number in addition to its MID within the request. The MID enables the target device to identify the initiator device while the TDC buffer number instructs the target to utilize a particular buffer (i.e., R1 or R2). Together the MID and TDC buffer number information permits the target device to select the correct target ready line for the current transaction. For a transaction request from I₂ to T₀, for example, the MID identifies I₂ as the sending initiator. Assuming that the TDC buffer number identifies R1 as the requested buffer, T₀ will deassert/assert ready line T(0)Ready21 during the ensuing transaction processing.

As seen in FIG. 3, each of AND gates 322, 324, 326, 328, 330, and 332, has four target ready inputs for accommodating a TDC system having up to four TDC capable targets. I₃ is a legacy delayed transaction device that does not support TDC and thus does not have target ready inputs. Thus, 13 will retry a “retried” transaction immediately as it would if implemented within a conventional delayed transaction environment. A target, such as T₃, that does not support TDC will not have target ready outputs. As depicted in FIG. 3, the ready inputs into AND gates 322, 324, 326, 328, 330, and 332 that correspond to the TDC slot in which T₃ is installed are connected by default to an asserted state. In this manner TDC initiator devices I₀, I₁, and I₂ will always perceive T₃ as being ready and will repeat retried transactions immediately just as in a conventional delayed transaction environment.

It should be noted that although the TDC logic employed in FIGS. 2 and 3 is AND gate logic, alternate embodiments may utilize other combinatorial logic for accomplishing the same goals. NOR logic using reverse logic polarity (logic low for ready line “assertion”) is one such example.

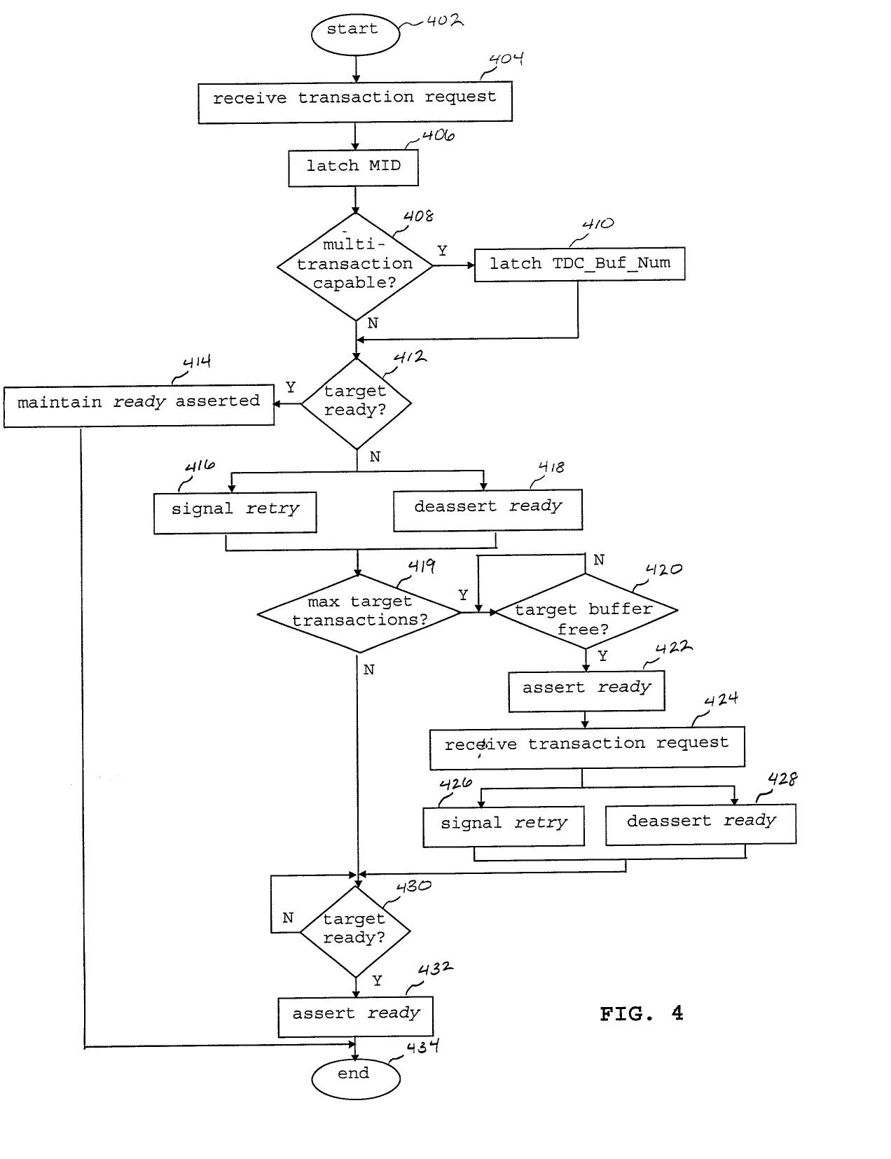

Referring to FIG. 4, there is illustrated a flow diagram depicting steps performed during a TDC bus transaction in accordance with a preferred embodiment of the present invention. The process begins at step 402 and proceeds to step 404 which illustrates receipt of a transaction request by a target device. The requested transaction may be a read or write request or any other data transaction carried over a shared bus. Next, as depicted at step 406, the Master ID of the sending initiator device is latched by the target device, thus enabling the target device to select a target ready output that is connected to the correct initiator device.

The process continues as illustrated at step 408 with a determination of whether or not the initiator device is capable of simultaneously processing more than one bus transaction. If so, and as shown at step 410 a TDC buffer number is latched by the target device, thus enabling the target device to further select the correct target ready output in accordance with a particular input target readiness buffer as identified by the initiator device in the original transaction request.

Proceeding to step 412, a determination is made of whether or not the target device is ready to process the current transaction request (the target may already have the read data buffered or an available write buffer in the case of a write, for example). If so, and as illustrated at step 414, the target device maintains assertion of the target ready output that was selected as per the information provided by steps 406 and 410 such that the request transaction may be completed. If however, as depicted at steps 416 and 418, the target device is not ready to process the current transaction request, the target device deasserts the selected target ready signal and delivers a retry response to the initiator device. Upon receipt of the retry response, the initiator device waits until the target ready signal is asserted before resending the transaction request.

If, as depicted at step 419, the target device is currently processing the maximum number of bus transactions that it supports at the time the current transaction request was received at step 404, the retry response and ready signal deassertion at steps 416 and 418 serve a pre-queueing function. In such a case, and as shown at steps 420 and 422, the target device asserts the selected target ready signal when a target buffer is freed. Upon assertion of the target ready signal at step 422, the target will not actually be ready to process the transaction, but it will now be ready to queue the transaction. Thus, the target device again responds with a retry message (step 426) and deasserts the target ready signal (step 428).

As illustrated at steps 430 and 432, the selected target ready signal is maintained deasserted until the target device is ready to process the requested transaction.

While the invention has been particularly shown and described with reference to a preferred embodiment, it will be understood by those skilled in the art that various changes in form and detail may be made therein without departing from the spirit and scope of the invention.

What is claimed is:

1. A method for reducing latency and overhead bandwidth consumption in computer bus transactions, said method comprising:
receiving a transaction request that is delivered over a shared bus from an initiator device to a target device;
in response to said target not being prepared to process said transaction request:
de-asserting a dedicated target ready signal
delivering a retry message from said target device to said initiator device over said shared bus; and
asserting said target ready signal in accordance with the readiness of said target device to process said transaction request.

2. The method of claim 1, wherein said target ready signal is asserted prior to and upon receipt of said transaction request by said target device.

3. The method of claim 1, wherein said step of de-asserting a target ready signal is performed in response to and in temporal proximity to said step of delivering a retry message.

4. The method of claim 1, wherein upon receipt of said retry message, said initiator determines whether or not said target ready signal is asserted, and in response to assertion of said target ready signal, said initiator redelivers said transaction request.

5. The method of claim 1, wherein in response to delivery of said retry message, said transaction request is terminated on said shared bus.

6. The method of claim 1, wherein following said receiving step, and in response to said target being prepared to process said transaction request, said method further comprises maintaining assertion of said target ready signal.

7. The method of claim 1, wherein said target ready signal is delivered from said target device to said initiator device over a dedicated signal line that may be external to or internal to said shared bus.

8. The method of claim 1, wherein a plurality of targets communicate over said shared bus, and wherein each of at least two of said targets includes a dedicated ready output for delivering a target ready signal to said initiator device, said method further comprising ANDing said ready outputs to produce a single target ready input signal delivered to said initiator device.

9. The method of claim 1, further comprising the step of associating a target ready output from said target device with said initiator device utilizing control information within said transaction request.

10. The method of claim 9, wherein said associating step further comprises latching the master identification address of said initiator device.

11. The method of claim 10, wherein said initiator device includes a plurality of target ready inputs, and wherein said associating step further comprises delivering a target directed completion buffer number from said initiator device to said target device, wherein said target directed completion buffer number identifies one of said plurality of target ready inputs.

12. An apparatus for reducing latency and overhead bandwidth consumption in computer bus transactions, said apparatus comprising:
a shared bus over which an initiator device delivers a transaction request to a target device; and
a target readiness detection circuit that delivers a ready signal from said target device to said initiator device in accordance with the readiness of said target device to process said transaction request.

13. The apparatus of claim 12, wherein said target readiness detection circuit is either external to or internal to said shared bus.

14. The apparatus of claim 12, further comprising a control line within said shared bus for delivering a retry message from said target device to said initiator device.

15. The apparatus of claim 12, further comprising a control line within said shared bus for delivering a master identification address from said initiator device to said target device.

16. The apparatus of claim 12, wherein said shared bus is shared by n or more initiator devices, and wherein said target readiness circuit comprises n target ready lines connecting said target device to each of n initiator devices, wherein said ready signal is delivered over a particular target ready line in accordance with the readiness of the corresponding target device to process a transaction request delivered from one of said n initiator devices.

17. The apparatus of claim 12, wherein said shared bus is shared by a plurality of target devices and n initiator devices, and wherein said target readiness detection circuit comprises:
n target ready outputs from each of said plurality of target devices, wherein each of said n target ready outputs from each target device is associated with one of said n initiator devices; and
a logic device for converting all target ready signals from target ready outputs that correspond to a single initiator device into a single target ready signal.

18. The apparatus of claim 17, wherein said logic device is an AND logic device.

19. The apparatus of claim 12, wherein said initiator device is capable of processing m bus transactions simultaneously, and wherein said target readiness circuit further comprises:
m target ready input buffers within said initiator device;
m target ready outputs from said target device;
signaling means within said initiator device for instructing said target device to utilize a particular target ready output corresponding to one of said m target ready input buffers; and
selection means within said target device for selecting one of said target ready outputs in accordance with instruction from said signaling means.

20. The apparatus of claim 19, further comprising a control line for delivering a target direct completion buffer number from said initiator device to said target device, wherein said target directed completion buffer number identifies one of said m target ready input buffers.

21. The apparatus of claim 12, wherein said shared bus is shared by a plurality of target devices and n initiator devices, and wherein said target readiness detection circuit comprises:
m target ready input buffers within each of said n initiator devices;
m logic devices associated with each of said n initiator devices for converting target ready signals from said target devices into m target ready signals that are each inputted into one of said m target ready input buffers; and
(n·m) target ready outputs from each of said target devices, wherein each target device includes m target ready outputs for each of said n initiator devices.
